(19) United States
(12) Patent Application Publication
(10) Pub. No.: US 2015/0067251 A1
(43) Pub. Date: Mar. 5, 2015

(54) Consolidated Parity Generation for Duplicate Files on a File Based RAID File System

(71) Applicant: Cisco Technology, Inc., San Jose, CA (US)

(72) Inventors: Dana Marlow Henriksen, Lindon, UT (US); Mel J. Oyler, Pleasant Grove, UT (US)

(73) Assignee: Cisco Technology, Inc., San Jose, CA (US)

(21) Appl. No.: 14/013,060

(22) Filed: Aug. 29, 2013

(51) Int. Cl. G06F 3/06

(52) U.S. Cl. CPC G06F 3/065; G06F 3/0614; G06F 3/0689
USPC 711/114; 711/162

(57) ABSTRACT

Consolidated parity generation may be provided. First, content from a linear feed may be received. The content may comprise content data. Next, parity data corresponding to the content data may be calculated. A plurality of content copies may then be saved. Each of the plurality of content copies may comprise a copy of the content data and a copy of the calculated parity data.

### BACKGROUND

Cloud computing uses computing resources delivered as a service over a network (e.g., the Internet). In cloud computing, a user's data, software, and computations are entrusted to remote services. Software as a service (SaaS) may be provided through cloud computing. In a business model that uses SaaS, users are provided access to application software and databases. Cloud computing providers manage the infrastructure and platforms on which the SaaS applications run. SaaS is sometimes referred to as “on-demand software” and is usually priced on a pay-per-use basis. One SaaS may comprise a network DVR (NDVR).

### BRIEF DESCRIPTION OF THE DRAWINGS

The accompanying drawings, which are incorporated in and constitute a part of this disclosure, illustrate various embodiments of the present disclosure. In the drawings:

FIG. 1 shows an operating environment;

FIG. 2 shows an operating environment;

FIG. 3 shows a data plane;

FIG. 4 is a flow chart of a method for providing consolidated parity generation; and

FIG. 5 shows a computing device.

### DETAILED DESCRIPTION

### Overview

Consolidated parity generation may be provided. First, content from a linear feed may be received. The content may comprise content data. Next, parity data corresponding to the content data may be calculated. A plurality of content copies may then be saved. Each of the plurality of content copies may comprise a copy of the content data and a copy of the calculated parity data.

Both the foregoing overview and the following example embodiment are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the example embodiment.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

A digital video recorder (DVR) may comprise a consumer electronics device or application software that records video in a digital format to, for example, a disk drive. Network DVR (NDVR), or network personal video recorder (NPVR), or remote storage digital video recorder (RS-DVR) is a network-based digital video recorder (DVR) stored at a service provider's central location rather than at the consumer's private home. Conventionally, media content was stored in a subscriber's set-top box hard drive, but with NDVR, the service provider owns a large number of servers, on which the subscribers' media content may be stored.

RS-DVR refers to a service where a subscriber can record a program and store it on the network. A stored program may only be available to a person who recorded it. Should any two persons record the same program, it must for legal reasons be recorded and stored as separate copies. Essentially implementing a traditional DVR with network based storage, cloud computing services may include RS-DVR services. Cloud RS-DVR services may comprise a solution to emulate a user's DVR in the cloud. By enabling recording in the cloud, recorded content may be accessed from a number of devices at any time.

Embodiments of the disclosure may provide a unique copy of a content program per user in a network based storage. When providing this network based storage, a Redundant Array of Independent Disks (RAID) may be used to store the content program on a per user basis. RAID may combine multiple disk drive components into a logical storage unit. With RAID, data may be distributed across the multiple disk drive components in one of several ways called “RAID levels”, depending on the level of redundancy and performance desired. RAID may describe computer data storage schemes that can divide and replicate data among multiple physical disk drives and is an example of storage virtualization; and the array can be accessed by an operating system as one single drive. The different schemes or architectures within RAID are named by the word RAID followed by a number (e.g. RAID 0, RAID 1). Each scheme provides a different balance between reliability and availability, performance, and capacity. RAID levels greater than RAID 0 may provide protection against unrecoverable (sector) read errors, as well as whole disk failure.

When multiple users want to record the same program on an NDVR, duplicate copies of the same content data are stored (e.g. one copy for each requesting user) in order to satisfy the legal “fair use” requirement. When the content data is written to (e.g. stored in) a file system, the RAID programming code (e.g. for file level RAID) processes the content data and calculates parity data for fault tolerance purposes. Because the parity data is a product of the content data processed, writing duplicate copies of content files results in duplicate parity calculations and duplicate parity blocks. Processing the file data blocks to produce the parity blocks uses considerable central processing unit (CPU) cycles, and when this work is duplicated, considerable CPU cycles may be wasted.

Consistent with embodiments of the disclosure, the aforementioned duplicate parity calculations may be reduced to free up the corresponding CPU cycles for other work. The duplicate parity calculations may be reduced or eliminated by generating the parity data for the recorded content once when the recorded content is first received and before the content data gets written to disk. Then, just as the main data blocks of the content data are written out multiple times (once for each copy), the once calculated parity blocks may also be written out multiple times (once for each copy) along with the content data. The file system needs to know to skip generating parity when the content data blocks are written since the parity calculation happened earlier. In this way, the parity calculation can be shared by each copy of the recording (e.g. content copy.) Consequently, the CPU cycles that would have been used doing duplicate parity calculations on duplicate data blocks can be freed.

Consistent with embodiments of the disclosure, the RAID parity data generation may be consolidated for duplicate copies of content data so that the parity calculations are done once, up front. The parity data can then be replicated for each copy of the content data rather than recalculated for each copy of the content data. Conventional systems do not address this problem. Rather with conventional systems, parity is generated at the block device layer resulting in no concept of duplicate data blocks.

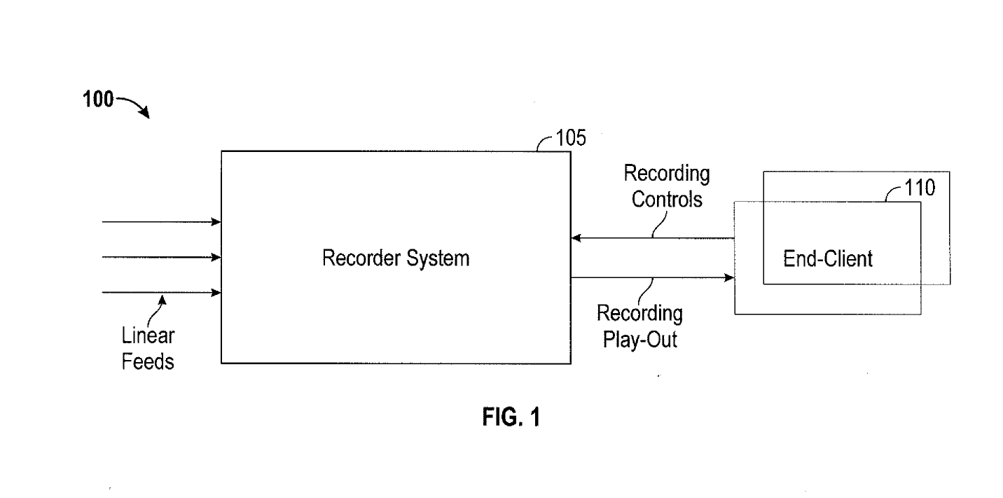

For file level RAID consistent with embodiments of the disclosure, this optimization may use a tight integration between the recording software and the storage software. Consequently, embodiments of the disclosure may integrate file level RAID with the recording software to provide this optimization to free up a significant amount of CPU cycles on the system. Similarly, embodiments of the disclosure may save on consumption of memory and system BUS. FIG. 1 is a block diagram of an operating environment 100. As shown in FIG. 1, operating environment 100 may include a recorder system 105 and end-clients 110. Recorder system 105 may receive a plurality of linear feeds. Content received from the plurality of linear feeds may be processed per recording controls received from end-clients 110 and recorder system 105 may provide recording play-out back to end-clients 110 in response. The plurality of linear feeds may comprise, but are not limited to, linear television channels.

Recorder system 105 may receive recording controls from end-clients 110 and provide recording play-out back to end-clients 110 over a network. The instructions to record (e.g. recording controls) may come from devices other than the user and/or end-clients 110. Moreover, the device sending the recording request and the device consuming the recording may not be same. The network may comprise any type of network (e.g., the Internet, a hybrid fiber-coaxial (HFC) network, a content delivery network (CDN), etc.) capable of facilitating control and playback. Furthermore, recorder system 105 may receive the plurality of linear feeds in any way including receiving the plurality of linear feeds over any type of network.

End-clients 110 may comprise, but is not limited to, a set-top box, a digital video recorder, a cable modem, a personal computer, a Wi-Fi access point, a cellular base station, a switch servicing multiple clients in a vicinity, a tablet device, a mobile device, a smart phone, a telephone, a remote control device, a network computer, a mainframe, a router, or other similar microcomputer-based device. End-clients 110 may comprise any type device capable of sending recording controls to recorder system 105 and receiving recording play-out back from recorder system 105 in response.

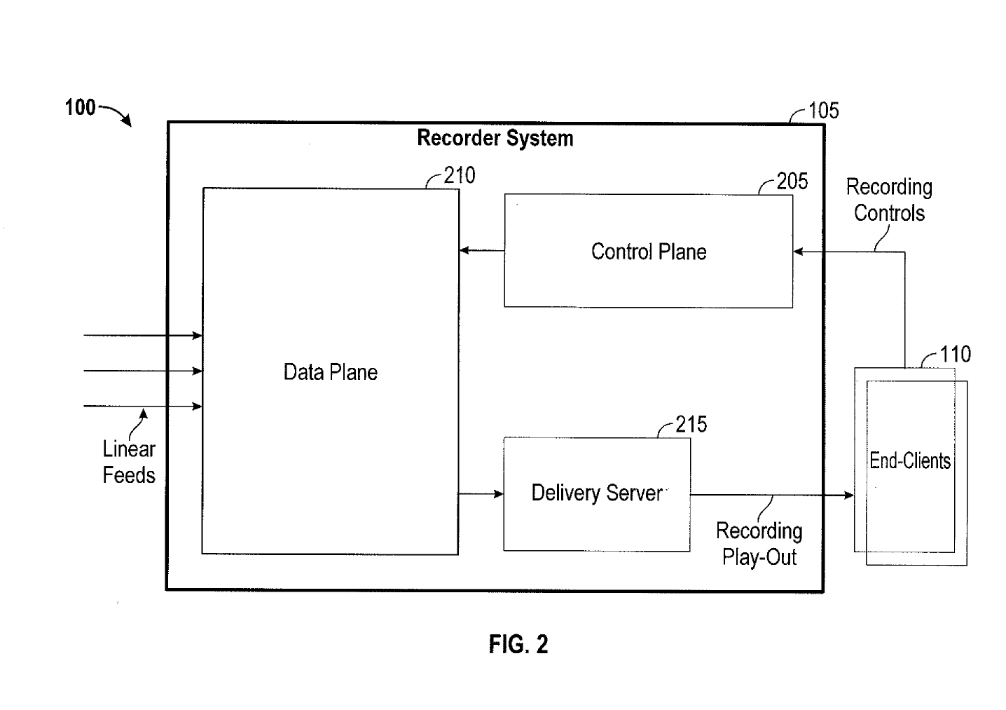

FIG. 2 is a block diagram showing operating environment 100 in greater detail. As shown in FIG. 2, recorder system 105 may comprise a control plane 205, a data plane 210, and a delivery server 215. Control plane 205 may interact with the users (e.g., through end-clients 110) to obtain recording commands (e.g., recording controls) and may schedule and manage recorder resources to be allocated for the recording defined by the users. Data plane 210 may then record ones of the linear feeds according to the schedule and under the management of control plane 205. Delivery server 215 may play-out the recorded content from data plane 210 to end-clients 110 (e.g., recording play-out).

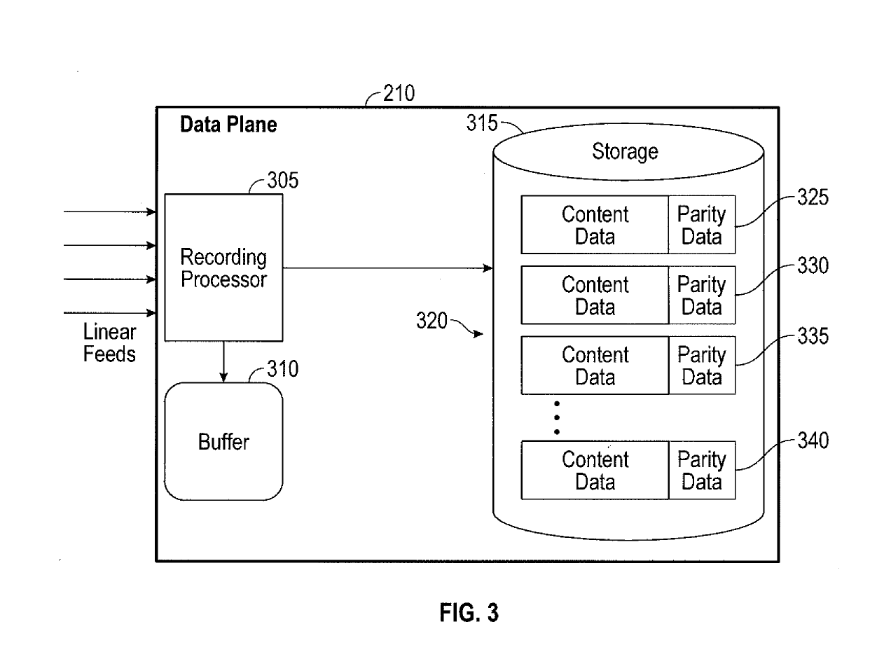

FIG. 3 is a block diagram showing data plane 210 in greater detail. As shown in FIG. 3, data plane 210 may comprise a recording processor 305, a buffer 310, and a storage 315. Recording processor 305 may receive content from ones of the plurality of linear feeds. The plurality of linear feeds may comprise, but are not limited to, linear television channels. Content from ones of the plurality of linear feeds may be temporarily saved in buffer 310 by recording processor 305. Recording processor 305 may be configured to record each of the plurality of linear feeds for a finite sliding time-window into buffer 310. Data in buffer 310 may not be exposed to users (e.g., through end-clients 110) and there may be no direct way for end-clients 110 to consume any content from buffer 310. From buffer 310, recording processor 305 may perform parity calculations on the data stored in buffer 310 and write multiple copies of the calculated parity data along with the content data to storage 315 as a plurality of content copies 320.

Storage 315 may comprise a Redundant Array of Independent Disks (RAID) that may combine multiple disk drive components into a logical storage unit. Recording processor 305 may store plurality of content copies 320 (e.g. a first content copy 325, a second content copy 330, a third content copy 335, up to an Nth content copy 340) in storage 315 on a per user basis. For example, first content copy 325 may correspond to a first user associated with a first one of end use clients 110, second content copy 330 may correspond to a second user associated with a second one of end use clients 110, and third content copy 335 may correspond to a third user associated with a third one of end use clients 110. System 100 may support any number of users and content copies up to Nth content copy 340 that may correspond to an Nth user associated with an Nth one of end use clients 110. Each one of plurality of content copies 320 may comprise the same content data and the same parity data.

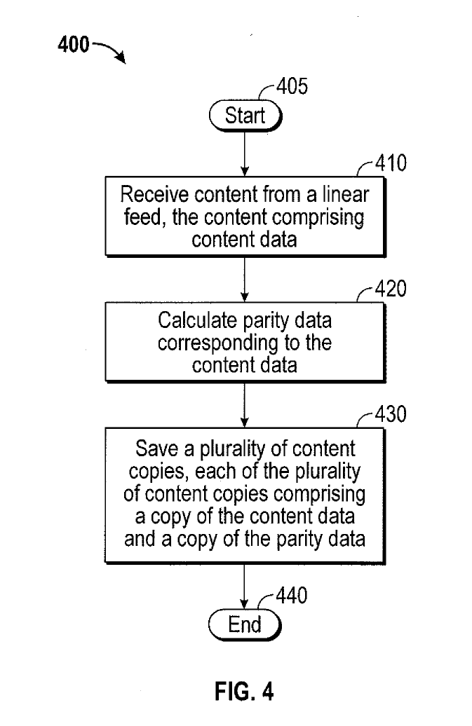

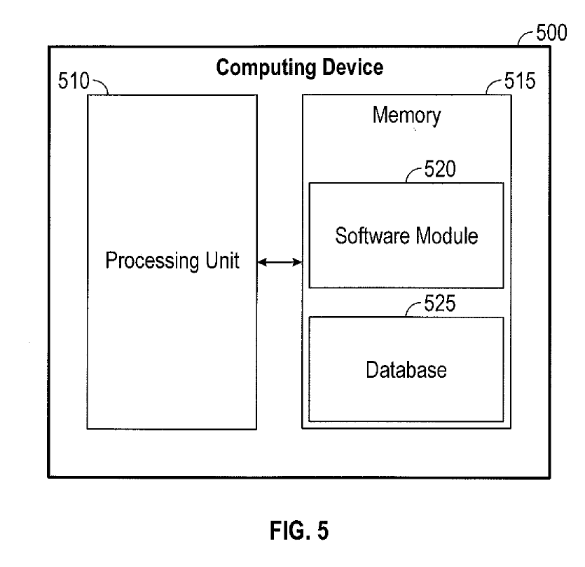

FIG. 4 is a flow chart setting forth the general stages involved in a method 400 consistent with an embodiment of the disclosure for providing consolidated parity generation. Method 400 may be implemented using recording processor 305. A computing device 500, as described in more detail below with respect to FIG. 5, may provide an operating environment for recording processor 305, for example. Ways to implement the stages of method 400 will be described in greater detail below.

Method 400 may begin at starting block 405 and proceed to stage 410 where recording processor 305 may receive content from a linear feed. The content may comprise content data. For example, recording processor 305 may receive the content data one of the plurality of linear feeds (e.g. a linear television channel.) This received content may be temporarily saved in buffer 310 by recording processor 305.

From stage 410, where recording processor 305 receives the content from the linear feed, method 400 may advance to stage 420 where recording processor 305 may calculate parity data corresponding to the content data. For example, recording processor 305 may perform parity calculations on the data stored in buffer 310. The parity data may be calculated for the recorded content in buffer 310 once when the recorded content is first received in buffer 310 and before the content data gets written to storage 315. Then, just as the main data blocks of the content data are written out multiple times (i.e. once for each of content copies 320), the once calculated parity blocks may also be written out multiple times (i.e. once for each of content copies 320) along with the content data. In this way, the parity data can be shared by each copy of the recording (e.g. each of content copies 320.) Consequently, the CPU cycles that would have been used doing duplicate parity calculations on duplicate data blocks can be freed.

Once recording processor 305 calculates the parity data corresponding to the content data in stage 420, method 400 may continue to stage 430 where recording processor 305 may save plurality of content copies 320. Each of plurality of content copies 320 may comprise a copy of the content data and a copy of the parity data. For example, after recording processor 305 performs the parity calculations (e.g. RAID parity calculations) on the data stored in buffer 310, recording processor 305 may write multiple copies of the calculated parity data along with the content data to storage 315 as plurality of content copies 320.

Consistent with embodiments of the disclosure, parity data calculations may be consolidated for duplicate copies of content data so that the parity calculations are done once, up front. The parity data can then be replicated for each copy of the content data rather than recalculated for each copy of the content data. With conventional systems, parity is generated at the block device layer resulting in no concept of duplicate data blocks. Once recording processor 305 saves plurality of content copies 320 in stage 440, method 400 may then end at stage 450.

An embodiment consistent with the disclosure may comprise a system for providing consolidated parity generation. The system may comprise a memory storage and a processing unit coupled to the memory storage. The processing unit may be operative to receive content from a linear feed. The content may comprise content data. In addition, the processing unit may be operative to calculate parity data corresponding to the content data and save a plurality of content copies. Each of the plurality of content copies may comprise a copy of the content data and a copy of the calculated parity data.

FIG. 5 shows computing device 500 in more detail. As shown in FIG. 5, computing device 500 may include a processing unit 510 and a memory unit 515. Memory unit 515 may include a software module 520 and a database 525. While executing on processing unit 510, software module 520 may perform processes for providing consolidated parity generation, including for example, any one or more of the stages from method 400 described above with respect to FIG. 4. Computing device 500, for example, may provide an operating environment for recording processor 305, recorder system 105, or any one of end-use clients 110. Recording processor 305, recorder system 105, or any one of end-use clients 110 may operate in other environments and are not limited to computing device 500.

Computing device 500 (“the processor”) may be implemented using a Wi-Fi access point, a cellular base station, a tablet device, a mobile device, a smart phone, a telephone, a remote control device, a set-top box, a digital video recorder, a cable modem, a personal computer, a network computer, a mainframe, a router, a smart TV-like device, a network storage device, a network relay devices, or other similar microcomputer-based device. The processor may comprise any computer operating environment, such as hand-held devices, multiprocessor systems, microprocessor-based or programmable sender electronic devices, minicomputers, mainframe computers, and the like. The processor may also be practiced in distributed computing environments where tasks are performed by remote processing devices. Furthermore, the processor may comprise, for example, a mobile terminal, such as a smart phone, a cellular telephone, a cellular telephone utilizing Wireless Application Protocol (WAP) or unlicensed mobile access (UMA), personal digital assistant (PDA), intelligent pager, portable computer, a hand held computer, a conventional telephone, or a Wireless Fidelity (Wi-Fi) access point. The aforementioned systems and devices are examples and the processor may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Moreover, the semantic data consistent with embodiments of the disclosure may be analyzed without being stored. In this case, in-line data mining techniques may be used as data traffic passes through, for example, a caching server or network router. Further, the disclosed methods' stages may be modified in any manner, including by reordering stages and/or inserting or deleting stages, without departing from the disclosure.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
receiving content from a linear feed, the content comprising content data;
calculating parity data corresponding to the content data; and
saving a plurality of content copies, each of the plurality of content copies comprising a copy of the content data and a copy of the calculated parity data.

2. The method of claim 1, wherein receiving the content comprises receiving the content comprising a television program.

3. The method of claim 1, wherein receiving the content comprises receiving the content at a buffer.

4. The method of claim 3, wherein receiving the content at the buffer comprises maintaining the content in the buffer within a finite sliding time-window.

5. The method of claim 1, wherein calculating the parity data comprises calculating the parity data on a file-by-file level.

6. The method of claim 1, wherein saving the plurality of content copies comprises saving the plurality of content copies wherein each of the plurality of content copies corresponds to an ender user.

7. The method of claim 1, wherein saving the plurality of content copies comprising saving the plurality of content copies at a network digital video recorder (NDVR).

8. The method of claim 1, wherein saving the plurality of content copies comprising saving to a redundant array of independent disks (RAID).

9. The method of claim 1, wherein saving the plurality of content copies comprising fanning data blocks corresponding to the plurality of content copies out over a number of disk drives.

10. The method of claim 1, further comprising recreating lost data blocks in the content data using the parity data.

11. An apparatus comprising:
a memory storage; and
a processing unit coupled to the memory storage, wherein the processing unit is operative to:
calculate parity data corresponding to received content data; and
save a plurality of content copies, each of the plurality of content copies comprising a copy of the content data and a copy of the calculated parity data.

12. The apparatus of claim 11, wherein processing unit being operative to calculate the parity data comprises the processing unit being operative to calculate the parity data on a file-by-file level.

13. The apparatus of claim 11, wherein processing unit being operative to save the plurality of content copies comprises the processing unit being operative to save the plurality of content copies wherein each of the plurality of content copies corresponds to an ender user.

14. The apparatus of claim 11, wherein the processing unit being operative to save the plurality of content copies comprising the processing unit being operative to save the plurality of content copies at a network digital video recorder (NDVR).

15. The apparatus of claim 11, wherein the processing unit being operative to save the plurality of content copies comprising the processing unit being operative to save to a redundant array of independent disks (RAID).

16. The apparatus of claim 11, wherein the processing unit being operative to save the plurality of content copies comprising the processing unit being operative to fan data blocks corresponding to the plurality of content copies out over a number of disk drives.

17. A computer-readable medium that stores a set of instructions which when executed perform a method executed by the set of instructions comprising:
receiving content from a linear feed, the content comprising content data;
calculating parity data corresponding to the content data; and
saving a plurality of content copies, each of the plurality of content copies comprising a copy of the content data and a copy of the parity data.

18. The computer-readable medium of claim 17, wherein calculating the parity data comprises calculating the parity data on a file-by-file level.

19. The computer-readable medium of claim 17, wherein saving the plurality of content copies comprises saving the plurality of content copies wherein each of the plurality of content copies corresponds to an ender user.

20. The computer-readable medium of claim 17, wherein saving the plurality of content copies comprising saving to a redundant array of independent disks (RAID).

21. The computer-readable medium of claim 17, wherein saving the plurality of content copies comprising fanning data blocks corresponding to the plurality of content copies out over a number of disk drives.

22. The computer-readable medium of claim 17, further comprising recreating lost data blocks in the content data using the parity data.
